(19) United States
(12) Patent Application Publication
(10) Pub. No.: US 2020/0223107 A1
(43) Pub. Date: Jul. 16, 2020

(54) SYSTEMS AND METHODS FOR ROTATIONAL MOLDING

(71) Applicant: Paxxal Inc., Noblesville, IN (US)

(72) Inventors: Omar Shawaf, Riyadh (SA); Ezzeldin Elmassry, Noblesville, IN (US); Ben Stoller, Orlando, FL (US); John Charny, Richmond Heights, OH (US); Ellwood Phillip Hunt, III, Orlando, FL (US); Thomas Richard Hopson, III, Greenwood, IN (US)

(73) Assignee: Paxxal Inc., Noblesville, IN (US)

(21) Appl. No.: 16/718,785

(22) Filed: Dec. 18, 2019

Related U.S. Application Data
(60) Provisional application No. 62/793,105, filed on Jan. 16, 2019.

(51) Int. Cl. B29C 41/06; B29C 41/46

(52) U.S. Cl. CPC B29C 41/06; B29C 41/22; B29C 41/46

(57) ABSTRACT

A rotational mold system includes at least two molds. A mold cavity is defined in each of the molds and designed to receive molding material that is injected into the mold cavity. Each of the molds is heated using one or more electric heaters that are directly attached to the mold or attached to a separate platen that is in contact with the mold. The heat transferred to the molds melts the molding material within the mold cavities, allowing the molding material to coat the inside walls of the molds as the molds are rotated.

### CROSS-REFERENCE TO RELATED APPLICATIONS

This application claims the benefit of U.S. Provisional Application No. 62/793,105, filed Jan. 16, 2019, which is hereby incorporated by reference.

### BACKGROUND

The present invention relates to systems for molding. In particular, the invention relates to systems for rotational molding of polymeric materials.

Historically, in a rotational molding process, a mold is filled with powdered molding material, and the mold is rotated in an oven. The oven is then heated to melt the molding material in the mold while the mold is rotated, distributing the powdered molding material around the interior of the mold. After a period of time of rotation, the mold is removed from the oven and cooled so that the molding material can set in a predetermined shape. The molded object is then removed from the mold.

Other rotational molding processes use oil as a heating or cooling means rather than an oven. In these processes, piping is included on the external surface of the mold and hot oil is run through the piping to heat the mold or cold oil is run through the piping to cool the mold.

The use of an oven to heat the mold by convection or the use of oil piping can be require large amounts of energy and therefore can become costly. It may also be difficult to control the mold temperature with these methods.

There is a need for improvement in this field.

### BRIEF DESCRIPTION OF THE DRAWINGS

FIG. 1 is a perspective view of a rotational molding system.

FIG. 2 is a perspective view of a pallet formed by the rotation molding system of FIG. 1.

FIG. 3 is a perspective view of a mold assembly of the rotational molding system of FIG. 1 in an open position.

FIG. 4 is a perspective view of the mold assembly of the rotational molding system of FIG. 1 in a closed position.

FIG. 5 is a perspective view of the rotational molding system of FIG. 1 with the mold assembly in a position for injection.

FIG. 6 is a perspective view of the rotational molding system of FIG. 1 with the mold assembly being injected with molding material.

FIG. 7 is a perspective view of an embodiment of a mold assembly in an open position.

FIG. 8 is a front view of the mold assembly of FIG. 7.

FIG. 9 is a perspective view of the mold assembly of FIG. 7 in a closed position.

FIG. 10 is a front view of the mold assembly of FIG. 9.

FIG. 11 is a flowchart for a method of forming an object using rotational molding.

FIG. 12 is a flowchart for a method of forming an object using rotational molding.

FIG. 13 is a flowchart for a method of forming an object using rotational molding.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

Rotational molding is one of several well-known methods of molding and may comprise the rotation of a mold, after part-filling with molding material, about two perpendicular axes typically to produce a polymeric or plastic hollow article. In a typical rotational molding process, a mold tool is filled with molding material. The mold is then heated to melt the molding material. While the molding material is melted, the mold is rotated so that the molding material coats the inside of the mold cavity. After a predetermined time, the mold is cooled, allowing the melted molding material to solidify so that the molding material forms the desired molded shape. The article removed from the mold.

Rotational molding is particularly useful for producing hollow articles. As pressure is applied in the insertion of the molding material in the mold, and also because the molding material is heated and cooled in the mold, the resulting molded article has relatively lower stress.

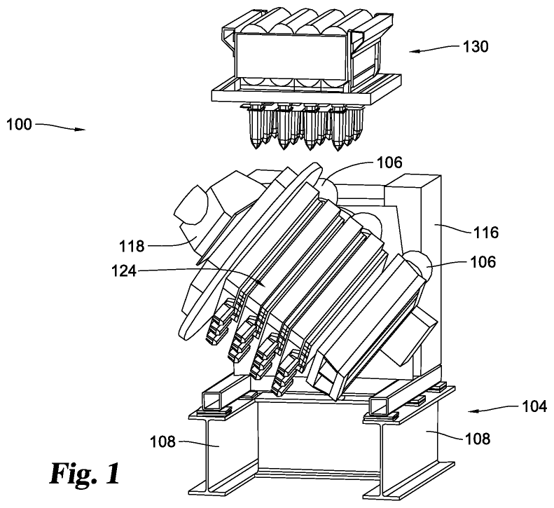

With reference to FIG. 1, a rotational mold system 100 is shown. The rotational mold system 100 has a base 104 which includes stationary supports 108. A rotational mold support 116 is positioned on top of the base 104 and may be removable from base 104 or may be permanently attached to base 104. Rotational mold support 116 includes a mold support frame 118. The mold support frame 118 is rotatable with respect to rotational mold support 116. A mold assembly 124 is attached to the mold support frame 118 so that the mold assembly rotates with the mold support frame 118.

Rotational mold system 100 also includes a filling system 130 that is positioned adjacent to the mold assembly 124. Filling system 130 may be positioned above mold assembly 124 as shown in FIG. 1, or in other embodiments, filling system 130 may be positioned on either side of mold assembly 124 or even beneath mold assembly 124. Rotational mold system 100 optionally includes one or more fans 106 directed toward mold assembly 124.

Rotational mold system 100 may be used to manufacture a wide range of molded articles. The embodiment shown in FIG. 1 is particularly suited for the manufacture of pallets. However, it should be understood that the rotational mold system 100 is not limited to the manufacture of pallets, but may be adapted for the manufacture of any other desired molded articles that may be formed by rotational molding.

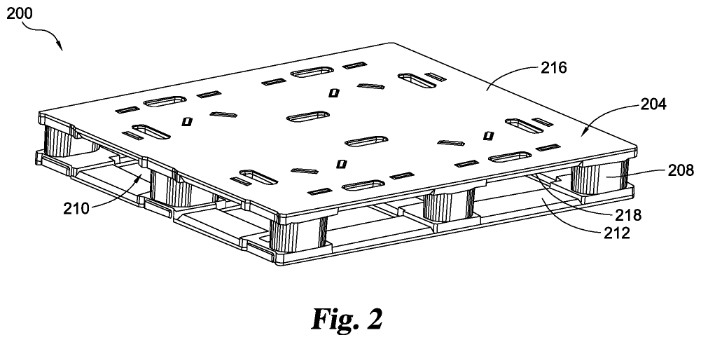

An example of a pallet 200 manufactured by the rotational mold system 100 is shown in FIG. 2. Pallet 200 includes a deck 204 and a plurality of blocks 208 integral with and extending from deck 204 to form a contiguous outer shell 210. Pallet 200 also includes a stringer 212 that is parallel to deck 204 and connected to blocks 208. Deck 204 and blocks 208 may be formed as a unitary piece that is connected to stringer 212.

Deck 204 has an upper surface 216 and a lower surface 218 that enclose a hollow interior. Blocks 208 extend from lower surface 218 of the deck 204. Deck 204 and blocks 208 form a contiguous outer shell that defines a common internal cavity that is formed by the interior of deck 204 and the interior of blocks 208. Similarly, stringer 212 may also be hollow to define an internal cavity. A support material may be used to fill or substantially fill the internal cavity defined within deck 204 and blocks 208 and the internal cavity defined within stringer 212.

In some embodiments, high density polyethylene (HDPE) may be used as a support material that fills or substantially fills the internal cavity defined within the deck 204 and blocks 208 or the internal cavity defined within stringer 212. The support material may be more rigid than the material used for the outer shell of deck 204, blocks 208, and/or stringer 212 to provide pallet 200 with additional strength. In some embodiments, the support material may be a foamed material that provides increased strength and rigidity but also is lighter than a solid material, to assist to reduce the overall weight of pallet 200. Additional support materials may be used to create a mixture of plastic and non-plastic materials that is used as the support material. As an example, these additional filler materials may be crushed minerals, silica sand, fibers, porous materials such as pumice and flue ash, and/or filler material as described in any of U.S. Pub. No. 2007/0063381, U.S. Pub. No. 2008/0110377, or U.S. Pat. No. 9,138,945.

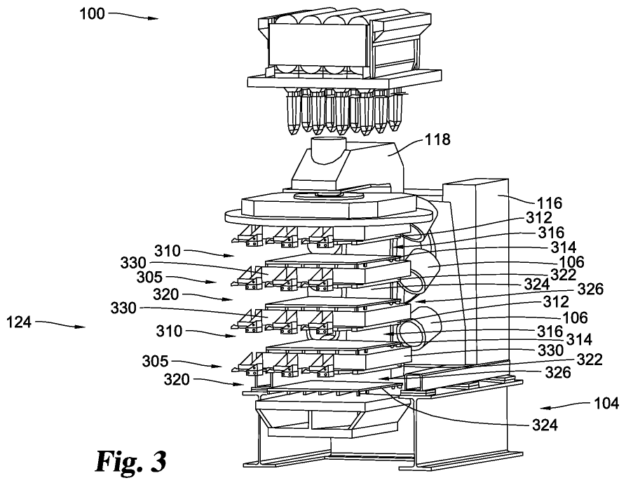

As shown in FIG. 3, mold assembly 124 includes pallet mold sets 305 that each include two separate molds for forming each portion of pallet 200. One of the molds in the pallet mold set 305 is an outer shell mold 310 for forming the outer shell of pallet 200. The other mold in the pallet mold set 305 is a stringer mold 320 for forming stringer 212 of pallet 200. Outer shell mold 310 includes two outer shell plates 312, 314 and stringer mold 320 also includes two stringer plates 322, 324. Outer shell mold 310 forms a separate mold from stringer mold 320 so that the outer shell comprising the deck and the blocks of the pallet is a separate piece than the stringer. Adjacent molds are separated by spacer element 330. Spacer elements 330 may optionally be thicker than plates 312, 314, 322 or 324. Each of plates 312, 314, 322 and 324 include one or a number of electrical heating elements that can selectively controlled to control the temperature of plates 312, 314, 322 and 324.

Each pallet mold set 305 may be used to create a single pallet 200, and as shown in FIG. 3, mold assembly 124 is capable of including multiple pallet molds sets 305 so that multiple pallets may be manufactured during a single rotation cycle of rotational mold system 100. In the embodiment shown, mold assembly 124 includes two pallet mold sets 305 with a first pallet mold set 305 stacked vertically on top of a second pallet mold set 305. In other embodiments, rotation mold system 100 may include a different number of pallet mold sets so that either more pallets or fewer pallets are made in the same rotation cycle. Additionally, the pallet mold sets 305 may be arranged vertically or arranged horizontally so that pallet mold sets are side by side. In embodiments with more than two pallet mold sets 405 it is also possible that pallet mold sets 305 are arranged vertically and horizontally.

Each pallet mold set 305 includes an outer shell mold 310 formed from a first shell plate 312 and a second shell plate 314. First shell plate 312 is separable from second shell plate 314 to allow removal of a completed outer shell once the molding material is cooled and solidified. An outer shell mold cavity 316 is formed between first shell plate 312 and second shell plate 314 when first shell plate 312 is in contact with second shell plate 314. Openings in outer shell mold 310 allow molding material to be injected into the outer shell mold cavity 316.

Each pallet mold set 305 also includes a stringer mold 320. Stringer mold 320 includes a first stringer plate 322 and a second stringer plate 324. First stringer plate 322 is separable from second stringer plate 324 to allow removal of a completed stringer once the molding material is cooled and solidified. A stringer mold cavity 326 is formed between first stringer plate 322 and second stringer plate 324 when first stringer plate 322 is in contact with second stringer plate 324. Openings in stringer mold 320 allow molding material to be injected into the stringer mold cavity 326.

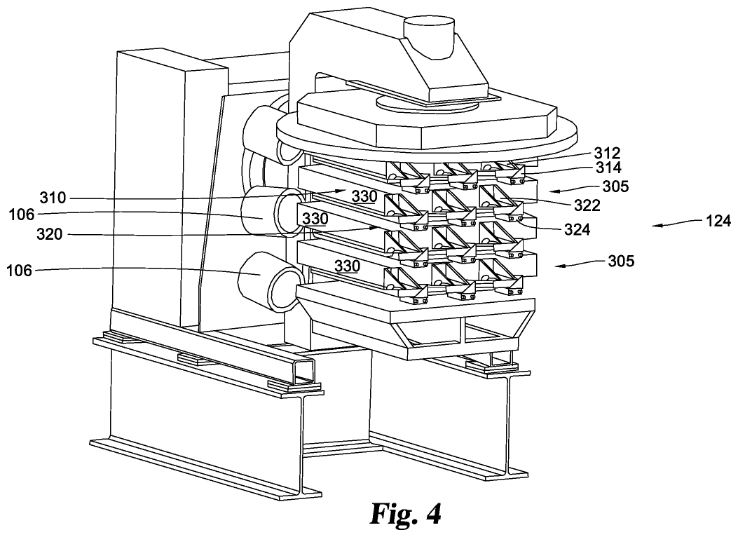

In FIG. 3 each of the pallet mold sets 305 are configured in an open position that allows for removal of a completed pallet 200. In FIG. 4, the pallet mold sets 305 of mold assembly 124 are arranged in closed position. In the closed position, each pallet mold set 305 is arranged so that the first shell plate 312 is in contact with the second shell plate 314, enclosing outer shell mold cavity 316 into which the molding material may be inserted. Likewise, the first stringer plate 322 is in contact with the second stringer plate 324, enclosing stringer mold cavity 326 into which the molding material may be inserted.

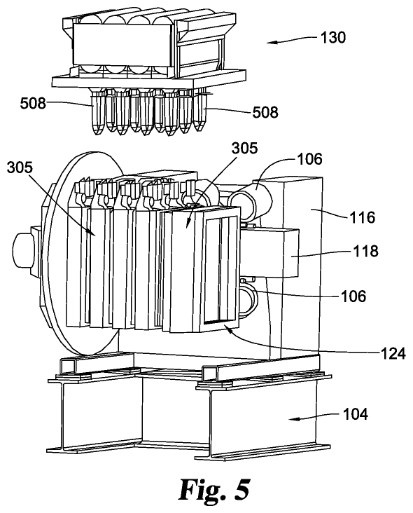

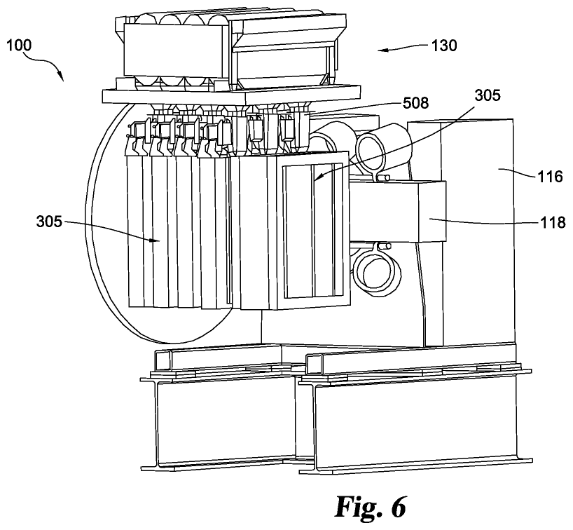

Once the pallet mold sets 305 are in the closed position, the pallet mold sets 305 may be filled using a filling process illustrated in FIGS. 5-6. The filling system 130 includes molding material injectors 508 that extend from the filling system 130 in the direction of the mold assembly 124. Mold support frame 118 is rotated so that the pallet mold sets 305 are positioned to receive molding material from injectors 508.

Filling system 130 is movable with respect to rotational mold support 116 and mold assembly 124 so that when the mold support frame 118 is rotating, filling system 130 is positioned away from the mold support frame 118 to give mold support frame 118 clearance to rotate. Once the mold support frame 118 has rotated to a position for filing pallet mold sets 305, filling system 130 may be moved toward the pallet mold sets so that the molding material injectors 508 are aligned with openings in the pallet mold sets 305 that allow for injection of the molding material into the mold cavities 316, 326 of the pallet mold sets 305.

In FIG. 5, the pallet mold sets 305 are rotated so that each pallet mold set 305 is positioned on its side so that molding material may be inserted into pallet mold sets 305 vertically. However, other embodiments may have different orientations for injecting the molding material depending on the position of the filling system 130 and the injection openings in the mold sets 305.

As shown in FIG. 6, once the pallet mold sets 305 are rotated into the correct position for injection, the filling system 130 is moved relative to the pallet mold sets 305 so that injectors 508 are positioned over injection openings in the pallet mold sets 305. The molding material is then injected from injectors 508 into each of the outer shell molds 310 and stringer molds 320. After the molds are filled with molding material, the filling system 130 is moved away from mold support frame 118 and into a position similar to what is shown in FIG. 5.

Once the molds from pallet mold sets 305 are filled with molding material, each of the molds 310, 320 are heated to melt the molding material. Heaters are directly attached to the mold or attached to a separate platen that is in intimate contact with the mold. The heaters may be electrical resistance heaters and are either mounted directly inside the mold or separate platen or may be attached to the surface of the mold or the platen. Examples of electrical resistance heaters that can be used include cartridge, strip, tubular, ceramic fiber, cast aluminum, thick film, coil/cable, foil, film, band or any other suitable type of electric resistance heater. In rotational mold system 100, cartridge heaters are directly positioned within cavities formed in the plates 312, 314, 322, 324 of pallet mold sets 305 so that there is no need for a separate platen between each of the mold sets 305 to provide heating.

Electric resistance heating provides several advantages over heating using other methods of heating, such as thermal fluid heating. Electric resistance heaters can be strategically placed within the molds 310, 320 to allow control over the variation of thickness at specific locations within the molds 310, 320. This specificity is much more difficult or even impossible to achieve with thermal fluid heating.

Electric heating also decreases the footprint of production machines needed for rotational molding by using more compact machines and by reducing the number of components for the rotational molding process. Having smaller machines with fewer components reduces production costs, maintenance costs, and power expenditure. Power expenditure is decreased for systems using electrical resistance heating due to the smaller mass of the molds and because there is no piping or oil that needs to be heated. Additionally, startup and shutdown time for electrical resistance heating assemblies is greatly reduced.

Electric resistance heating is more environmentally friendly and safer than thermal fluid heating. There is no oil used in electric resistance heating, eliminating the threat of oil leakage and reducing the risk of burns due to hot surfaces or high pressure oil leaks. Thermal fluid heating generates fumes from exposed oil evaporating from hot surfaces. These fumes are not generated during electric resistance heating does. Additionally, a large amount of energy is used to preheat the oil used in thermal fluid heating. The oil must also be cooled by a chiller system and, eventually, the oil must be replaced and disposed of safely to avoid environmental damage. These issues are not present in electric resistance heating where oil is not used to heat the molds 310, 320.

Cooling the pallet mold sets 305 to set the molding material may be accomplished using any of a variety of suitable methods. In one embodiment, fans are positioned on rotational mold system 100 to increase airflow around the pallet mold sets 305 in mold assembly 124. The position of the fans may be chosen to optimize the airflow around pallet molds sets 305.

In another embodiment, rotation of the rotational mold system 100 is stopped once the temperature of the mold assembly 124 reaches a predetermined temperature, such as 40° C. After reaching the predetermined temperature, fans drive high humidity air into the mold assembly 124. Diverters may be used in conjunction with the fans to move the air to desired locations within the mold assembly 124, near pallet mold sets 305. Heat transfer between the high humidity air and the pallet mold sets 305 cools the pallet mold sets 305, causing the molding material to set within the molds.

Ducts in fluid communication with the rotational mold system 100 are used to remove the heated air from the rotational mold system 100. The heated air may be exhausted outside or to another area exterior of the rotation mold system 100. In some embodiments, the heated air may be directed to a different rotational mold system 100 and used to heat the molds in that separate rotational mold system 100.

In some embodiments, instead of introducing high humidity air into the pallet mold sets 305 using fans, other methods of humidifying the air could be also be used. This humidified air has a larger specific heat than air that has not been humidified and allows for increased heat transfer between the pallet mold sets 305 and the surrounding air. In other embodiments, cooling the air around the pallet mold sets 305 may increase heat transfer and decrease the amount of time needed to cool the pallet mold sets 305. Cooling may be accomplished using air conditioning or any other suitable method of decreasing air temperature.

In another embodiment, water cooling lines are attached to the pallet mold sets 305. Cold water is passed through the water cooling lines to promote heat transfer from the pallet mold sets 305 to the water cooling lines, cooling the pallet mold sets 305. In other embodiments, water may be sprayed directly on to the pallet mold sets 305 to cool the pallet mold sets 305. In this embodiment, any electronics or other hardware that assists in operation of the rotational mold system 100 should be ensured to be waterproof so that spraying the pallet mold sets 305 does not disrupt operation of the rotational mold system 100.

In an alternative embodiment, the pallet mold sets 305 are removed from rotational mold system 100 for cooling after rotation has been completed. Removing the pallet mold sets 305 from the heat provided in the rotational mold system allows the molding material to cool and set in the desired shape. After the pallet mold sets 305 are removed, a new set of pallet molds may be inserted into rotational mold system 100. In some embodiments, this new sets of pallet molds is preheated to a temperature at which the molding material begins to melt, but not to a temperature which causes the molding material to stick to the pallet molds at an undesired location without rotation. Preheating reduces the amount of time that the pallet mold sets sped in rotational mold system 100 allowing increased production.

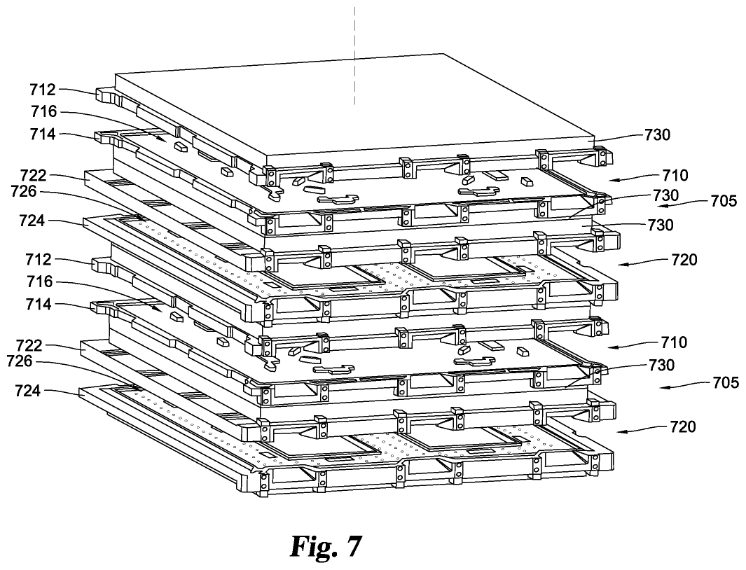

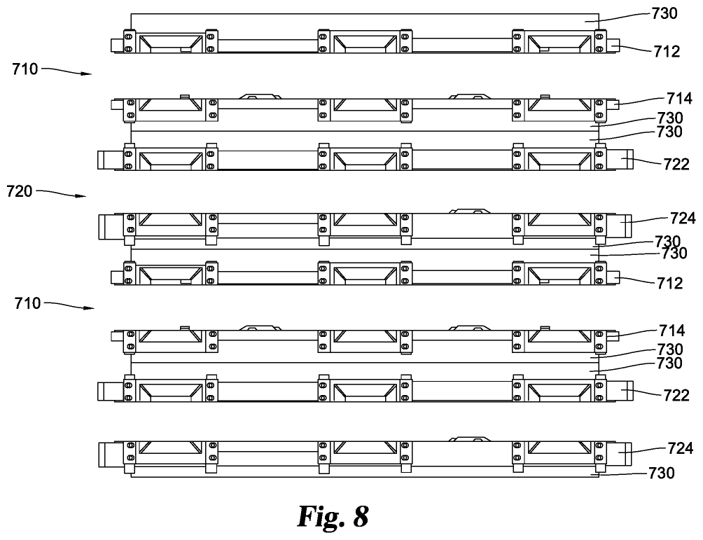

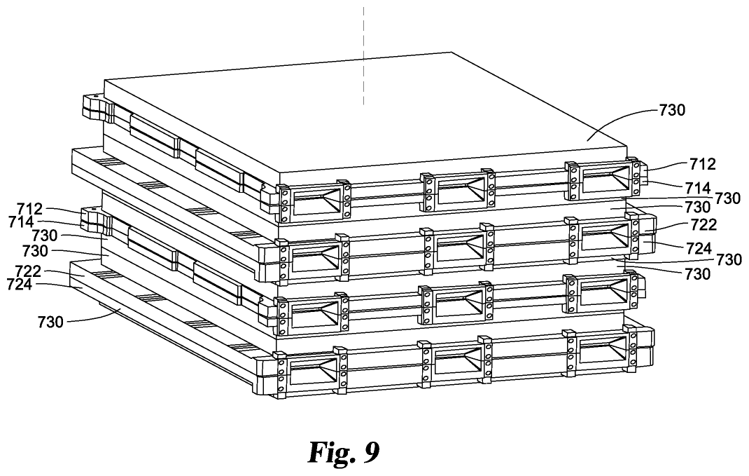

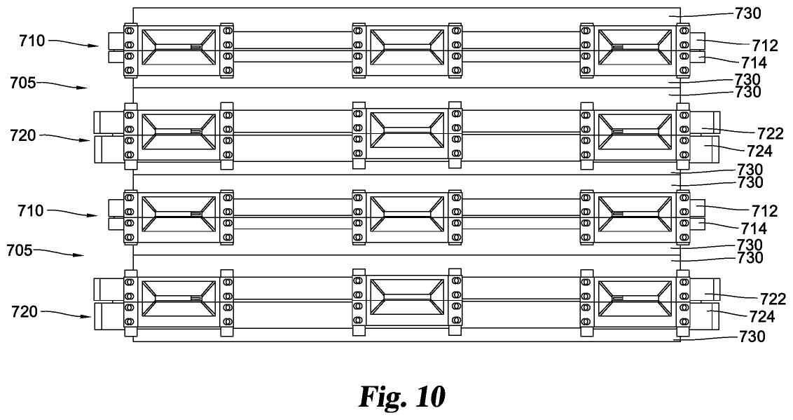

An alternative embodiment of the mold sets using platens to provide heat to the mold plates is shown in FIGS. 7-10. Two pallet mold sets 705 are illustrated in a stacked arrangement so that one pallet mold set 705 is positioned above a second pallet mold set 705. Each pallet mold set 705 includes an outer shell mold 710 having a first shell plate 712 and a second shell plate 714 and a stringer mold 720 including a first stringer plate 722 and a second stringer plate 724. Pallet mold sets 705 are shown in an open position in FIGS. 7 and 8 and shown in a closed position in FIGS. 9 and 10.

A heated platen 730 is adjacent to and in contact with the upper surface of first shell plate 712. Another heated platen 730 is adjacent to and in contact with the lower surface of second shell plate 714. Similarly, a heated platen 730 is adjacent to and in contact with the upper surface of first stringer plate 722. Another heated platen 730 is adjacent to and in contact with the lower surface of second stringer plate 724. Each mold plate 712, 714, 722, 724 includes its own adjacent heated platen 730 so that two stacked heated platens 730 are positioned between adjacent outer shell molds 710 and stringer molds 720.

Electric resistance heaters may be inserted directly into a heated platen 730 and/or may be positioned on a surface of multiple surfaces of the heated platen 730. As an example, cartridge heaters may be inserted to cavities within heated platen 730. In another example, the platens 730 are heated by strip electric resistance heaters that are attached to the surface of platen 730. In other embodiments, any other type of suitable electric heater may be used to heat platens 730.

Heat from the electric heaters attached to or inserted inside the heat platens 730 is transferred by the heat platen 730 to the adjacent mold plate 712, 714, 722, or 724. The heat transferred to the mold plate is then transferred to a molding material that is inserted into shell mold cavity 716 formed between first shell plate 712 and the second shell plate 714 or stringer mold cavity 726 formed between the first stringer plate 722 and the second stringer plate 724. The transferred heat causes the molding material to melt so that when the pallet mold sets 705 are rotated, the molding material coats the inside of the shell mold cavity 716 between the first shell plate 712 and the second shell plate 714 or the stringer mold cavity 726 between the first stringer plate 722 and the second stringer plate 724.

In some embodiments, the heated platens 730 are maintained above a minimum temperature, for example, above 120° C. The shell plates 712, 714 of the outer shell mold 710 are held together using a latch and heated by heated platens 730 adjacent the shell plates 712, 714. Likewise, the stringer plates 722, 724 of the stringer mold 720 are held together using a latch and heated by adjacent heated platens 730. After heating and rotation, the outer shell mold 710 and the stringer mold 720 are removed from rotational mold system 100 while the molds 710, 720 are still hot. Removing the molds 710, 720 from the heated platens 730 reduces the mass that needs to be cooled as heat transfer is not wasted on the heated platens 730. Removal of the molds 710, 720 for cooling also reduces the amount of energy needed to reheat the heated platens 730 for rotational molding of a subsequent set of molds.

The molds 710, 720 are then cooled by any of a variety of methods. In one embodiment, the molds are 710, 720 are submerged in water or another cooling liquid to be cooled. Alternatively, water or any other form of cooling liquid is sprayed on the molds 710, 720. In other embodiments, air or cooled air is blown on the molds 710, 720 to encourage heat transfer with the surrounding environment. In another embodiment electric cooling plates are used to cool molds 710, 720.

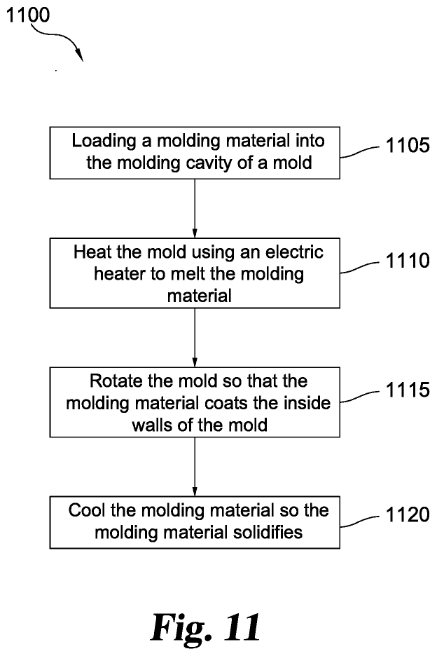

A method of forming an object using rotational molding is shown in flowchart 1100, illustrated in FIG. 11. In a first step 1105, a molding material is loaded into the molding cavity of a mold. For the pallet mold sets 305, the molding material is inserted into the outer shell molding cavity and into the stringer molding cavity. The rotational molding system may include multiple molds, so that molding material is loaded into the molding cavities of each of the molds.

In a second step 1110, the mold or molds are heated using an electric heater. Heating the molds melts the molding material or at least softens the molding material to a point where the molding material is pliable. A single electric heater or multiple electric heaters may be used to heat the molds. In some embodiments, electric heaters are directly attached to the mold, either by positioning the electric heater on the surface of the mold or by inserting the electric heaters directly into cavities or other interior portions of the mold. In other embodiments, the electric heaters are attached to separate platens that are in contact with the mold. The platen is heated and heat from the platen is then transferred to the mold to melt the molding material within the mold cavity.

In the third step 1115, the mold or molds are rotated. While the mold is rotating, the melted or softened molding material is dispersed within the mold cavity so that the molding material coats the inside walls of the mold. Rotation can begin as the molds are heated by the electric heater. Continuous rotation during heating allows the molding material to evenly coat the inside walls of the mold with a uniform thickness, preventing deformation and increasing the strength of the molded object.

In the fourth step 1120, the electric heaters are turned off, and the molding material is allowed to cool and solidify in the shape defined by the mold. Typically, the mold continues to rotate during the cooling process to maintain a uniform thickness of the molding material during solidification. After cooling, the molds are opened and the molded articles are removed from the molds.

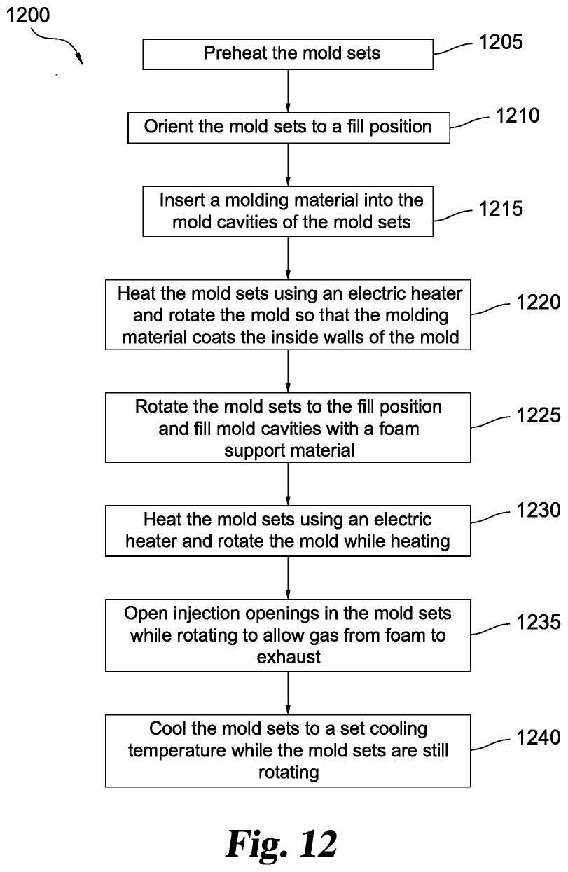

A method of forming pallets using the pallet mold sets 305 is shown in flowchart 1200, illustrated in FIG. 12. In a first step 1205, the pallet mold sets 305 are preheated either before the start of rotation or while the pallet mold sets 305 are rotated. Once preheating is completed, in a second step 1210, the pallet mold sets 305 are oriented in a fill position so that injection openings in the pallet mold sets 305 are positioned vertically so that the injection openings may be accessed by the filling system 130. The filling system 130 is moved relative to the pallet mold sets 305 so that the molding material injectors 508 are aligned with the injection openings.

In a third step 1215, fill material is inserted into the outer shell mold cavities 316 and the mold stringer cavities 316 of the pallet mold sets 305. Once the mold cavities 316, 326 are filled with a fill material, the injection openings are covered and sealed. In a fourth step 1220, the pallet mold sets 305 are then rotated and heated by electrical heaters to a set temperature. This set temperature is maintained as the pallet mold sets 305 continue to rotate for a determined period of time until the fill material is able to uniformly coat the inside walls of the pallet mold sets 305. In a fifth step 1225, the pallet mold sets 305 are then rotated back to the initial fill position where the injection openings are accessible to the filling system 130. The injection openings are uncovered and a foam support material is inserted into the outer shell cavities 316 and the stringer cavities 316 of the pallet mold sets 305. The injection openings are then recovered and sealed.

In a sixth step 1230, after adding the foam support material, the pallet mold sets 305 are again rotated and heated during rotation by electrical heaters to a set temperature. In a seventh step 1235, the pallet mold sets 305 continue to rotate and the injection openings are uncovered and unsealed during rotation to allow gases from the foam to be exhausted from the outer shell cavities 316 and the stringer cavities 316 of the pallet mold sets 305. Sequential heating using the electrical heaters continues while the gases are exhausted from the pallet mold sets 305. After the excess gas has been removed from the foam, the injection openings are once again closed and the pallet mold sets 305 are still heated while being rotated. In an eighth step 1240, after sufficient heating time has elapsed, the pallet mold sets 305 continue to rotate as the pallet mold sets 305 are cooled to a set cooling temperature.

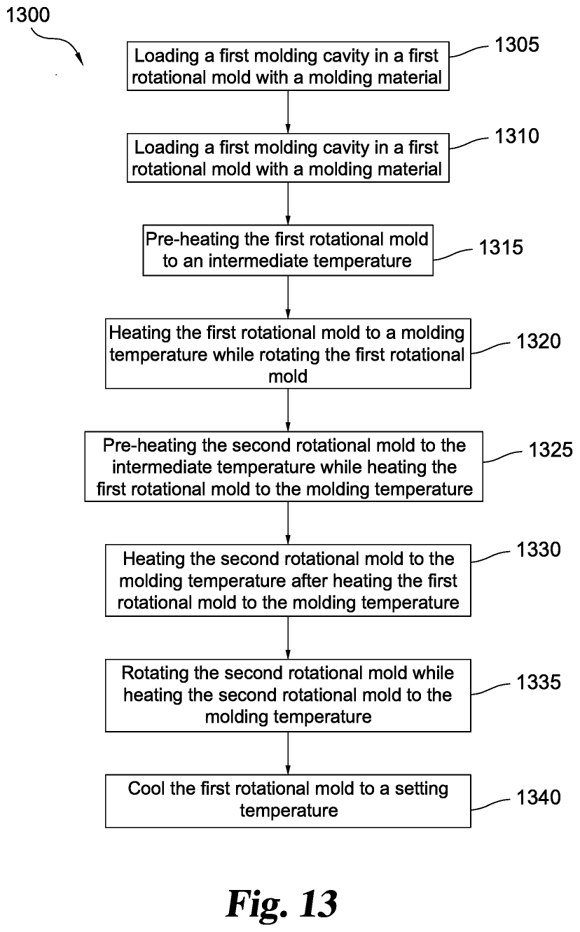

An alternative method of forming objects using rotational molding is shown in flowchart 1300, illustrated in FIG. 13. In a first step 1305, a molding material is loaded into a first molding cavity in a first rotational mold. In a second step 1310, a molding material is loaded into a second molding cavity in a second rotational mold. The first rotational mold and the second rotational mold may be for molding the same part or may be for molding different parts.

In a third step 1315, the first rotational mold is pre-heated to an intermediate temperature. The intermediate temperature is a temperature that is above room temperature but below the temperature at which the molding material inside the rotational mold fully melts. The first rotational mold may be pre-heated while the first rotational mold is in the rotational mold system or the first rotational mold may be pre-heated while the first rotational mold is not in the rotational mold system and then installed in the rotational mold system after pre-heating.

After adding the foam support material, the pallet mold sets 305 are again rotated and heated during rotation by electrical heaters to a set temperature. The pallet mold sets 305 continue to rotate and the injection openings are uncovered and unsealed during rotation to allow gases from the foam to be exhausted from the outer shell mold cavity 316 and the stringer mold cavity 326 of the pallet mold sets 305. Sequential heating using the electrical heaters continues while the gases are exhausted from the pallet mold sets 305. After the excess gas has been removed from the foam, the injection openings are once again closed and the pallet mold sets 305 are still heated while being rotated. After sufficient heating time has elapsed, the pallet mold sets 305 continue to rotate as the pallet mold sets 305 are cooled to a set cooling temperature.

In a fourth step 1320, the first rotational mold is heated from the intermediate temperature to a molding temperature while the first rotational mold is rotated. The molding temperature can be any temperature that causes the molding material to melt so that the molding material coats the inside of the mold cavity upon rotation of the rotational mold. In a fifth step 1325, the second rotational mold is pre-heated to the intermediate temperature while the first rotational mold is rotated and heated to the molding temperature.

After pre-heating, the second rotational mold heated to the molding temperature in a sixth step 1330. In a seventh step 1335, the second rotational mold is rotated while the second rotational mold is heated to the molding temperature. In an eighth step 1330, the first rotational mold is cooled to a setting temperature. The setting temperature may be any temperature at which the molding material is cool enough to maintain its shape under the influence of gravity. In some embodiments, the eighth step 1340 may be performed simultaneously with the sixth step 1330 and/or the seventh step 1335. In other embodiments, the cooling in the eighth step 1340 is performed after heating and rotating the second rotational mold in the sixth step 1330 and the seventh step 1335. Cooling the first rotational mold may be accomplished using any desired method, including the methods already discussed above. For example, cooling the first rotational mold may include blowing air over the first rotational mold, humidifying the air before blowing it over the first rotational mold, and/or ducting the air away from the first rotational mold after the air passes over the first rotational mold.

In some embodiments, more than two rotational molds may be included in the method forming objects using rotational molding shown in flowchart 1300. In these embodiments, a molding material is loaded into a third molding cavity defined in a third rotational mold. The third rotational mold is pre-heated to the intermediate temperature. A heating plate assembly may then be positioned between the first and third rotational molds and the first and third rotational molds are heated to the molding temperature using the heating plate assembly. While the first and third rotational molds are heated to the molding temperature, the heating plate assembly and the first and third rotational molds are rotated in the rotational mold system.

The first and third rotational molds are then cooled to the setting temperature where the molding material maintains its shape under the influence of gravity. Once the setting temperature is reached, the first and third rotational molds are removed from the heating plate assembly and continue cooling then continue cooling after they are removed from the heating plate assembly.

In some embodiments, a fourth rotational mold may be added. While the heating plate assembly is maintained at or near the setting temperature, a molding material is loaded into a fourth molding cavity defined in a fourth rotational mold. The fourth rotational mold is then pre-heated to the intermediate temperature. After pre-heating, the heating plate assembly is used to heat the second and fourth rotational molds to the molding temperature while the second and fourth rotational molds are rotated. After heating to the molding and sufficient rotation, the second and fourth rotational molds are cooled to the setting temperature and removed from the heating plate assembly.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A rotational molding system, comprising:
a first rotatable mold including a first plate and a second plate, wherein said first plate and said second plate define a first molding cavity;
a second rotatable mold including a third plate and a fourth plate, wherein said third plate and said fourth plate define a second molding cavity;
a heating plate assembly including a heated platen, wherein said heating plate assembly is positioned between said first rotatable mold and said second rotatable mold; and
wherein said heating plate assembly is adapted to transfer heat to said first rotatable mold and to said second rotatable mold to at least partially melt a molding material injected into said first molding cavity and to at least partially melt a molding material injected into said second molding cavity.

2. The rotational molding system of claim 1, wherein said heating plate assembly is in direct contact with said first rotatable mold and said second rotatable mold; and

3. The rotational molding system of claim 1, wherein said heating plate assembly is sandwiched between said first rotatable mold and said second rotatable mold.

4. The rotational molding system of claim 1, wherein said heating plate assembly includes a first heated platen and a second heated platen.

5. The rotational molding system of claim 4, wherein said first heated platen is in direct contact with said first rotatable mold, and wherein said second heated platen is in direct contact with said second rotatable mold.

6. The rotational molding system of claim 4, wherein each of said first plate, said second plate, said third plate, and said fourth plate are in direct contact with one of said first heated platen or said second heated platen.

7. The rotational molding system of claim 1, wherein said first rotational mold and said second rotational mold are operationally connected so that rotation of the rotational mold system rotates both the first rotational mold and the second rotational mold together.

8. The rotational molding system of claim 1, further comprising:
a fan positioned adjacent said first rotatable mold and said second rotatable mold;
wherein said fan is adapted to increase air flow near said first rotatable mold and said second rotatable mold to assist in cooling said first rotatable mold and said second rotatable mold.

9. The rotational molding system of claim 1, wherein said first molding cavity of said first rotatable mold and said second molding cavity of said second rotatable mold each define a top deck for a pallet.

10. The rotational molding system of claim 1, wherein said first molding cavity of said first rotatable mold and said second molding cavity of said second rotatable mold each define a stringer for a pallet.

11. The rotational molding system of claim 1, wherein said first molding cavity of said first rotatable mold defines a top deck for a pallet and said second molding cavity of said second rotatable mold defines a stringer for a pallet.

12. A rotational molding system, comprising:
a first rotatable mold including a first plate and a second plate, wherein a first molding cavity is defined between said first plate and said second plate;
a second rotatable mold including a third plate and a fourth plate, wherein a second molding cavity is defined between said third plate and said fourth plate;
a plurality of electric heaters, wherein at least one of said plurality of electric heaters is operatively connected to a corresponding each one of said plates of said first rotatable mold and of said second rotatable mold, and
wherein said plurality of electric heaters is adapted to transfer heat to said rotatable molds to at least partially melt a molding material injected into the molding cavity.

13. The rotational molding system of claim 12, wherein each of said electric heaters is in direct contact with said corresponding plate.

14. The rotational molding system of claim 12, wherein said electric heaters are inserted into cavities within said plates.

15. The rotational molding system of claim 12, wherein said first rotational mold and said second rotational mold are operationally connected so that rotation of the rotational mold system rotates both the first rotational mold and the second rotational mold together.

16. The rotational molding system of claim 12, wherein said first molding cavity of said first rotatable mold defines a top deck for a pallet and said second molding cavity of said second rotatable mold defines a stringer for a pallet.

17. The rotational molding system of claim 12, further comprising:
at least two rotatable pallet mold sets, wherein each pallet mold set includes said first rotatable mold and said second rotatable mold;
wherein said first rotatable mold is an outer shell mold having a first shell plate and a second shell plate to form a top deck for a pallet; and,
wherein the second rotatable mold is a stringer mold having a first stringer plate and a second stringer plate to form a stringer for a pallet.

18. A method of forming molded objects, comprising:
loading a molding material into a first molding cavity defined between a first plate and a second plate of a first rotatable mold;
loading a molding material into a second molding cavity defined between a third plate and a fourth plate of a second rotatable mold;
stacking said first rotatable mold, said second rotatable mold and a heating plate assembly;
heating said first rotatable mold and said second rotatable mold using said heating plate assembly to at least partially melt said molding material within said first molding cavity and said molding material within said second molding cavity by transferring heat from said heating plate assembly to said first rotatable mold and to said second rotatable mold, wherein said heating plate assembly includes a heated platen and wherein said heating plate assembly is positioned between said first rotatable mold and said second rotatable mold;
rotating said first rotatable mold and said second rotatable mold in a rotational mold system so that said molding material coats the inside walls of the first plate and the second plate within the first molding cavity and so that said molding material coats the third plate and the fourth plate within the second molding cavity; and
cooling the molding material so that said molding material within said first molding cavity and said molding material within said second molding cavity solidifies.

19. The method of claim 18, further comprising:
removing said first rotatable mold and said second rotatable mold from said rotational mold system; wherein said removing is performed before said cooling the molding material.

20. The method of claim 19, further comprising:
arranging a third rotatable mold and a fourth rotatable mold in said rotational mold system so that heat is transferred from the heating plate assembly to said third rotatable mold and a fourth rotatable mold after said first rotatable mold and said second rotatable mold have been removed from said rotational mold system, and
wherein said heating plate assembly is maintained above a minimum temperature that is greater than the temperature of said third rotatable mold and said fourth rotatable mold while said third rotational mold and said fourth rotatable mold are arranged within said rotational mold system.

21. The method of any of claims 20, further comprising, filling said first molding cavity with a foamed support material.
